(19) United States
(12) Patent Application Publication
(10) Pub. No.: US 2003/0225639 A1
(43) Pub. Date: Dec. 4, 2003

(54) Method and system for managing and administering a supplemental unemployment benefit plan

(75) Inventor: Marci Micciantuono, Huntington, NY (US)

Correspondence Address: Philip Braglnsky, Scully, Scott, Murphy & Presser, 400 Garden City Plaza, Garden City, NY, 11530, US

(73) Assignee: Transition Services, Inc, Stamford, CT (US)

(21) Appl. No.: 10/159,452

(22) Filed: May 31, 2002

(51) Int. Cl. G06F 17/60

(52) U.S. Cl. 705/30

(57) ABSTRACT

The invention automates the administration of a supplemental unemployment benefits plan by utilizing an interactive automated response system. The automated response system provides for a user to interact with a personal profile database, a benefits database, and a calculator. The calculator calculates a benefit amount and the invention provides the user with the benefit.

Supplemental Unemployment Benefit (“SUB”) plans are company provided benefit plans that supplement the unemployment compensation paid by States to employees who have been involuntarily separated from employment. These plans provide compensation to employees in addition to any State unemployment insurance. Typically, these plans are financed by the employer and benefits are paid to employees due to their involuntary separation from employment. The benefit to the employer of these plans are the enhanced benefits to the displaced employees and cost savings to the employees.

Although provided for by the IRS since the 1950s, these plans have not been widely adopted and implemented. The reason for their limited use is mainly due to the complicated administration and management associated with these plans. Some examples of the complicated attributes of these plans are (i) monitoring the employment status of the displaced employees and (i) verifying and reconciling the unemployment benefits paid by the States.

Since unemployment benefit plans have historically been administered to by human resource personnel without the aid of automated systems, the plans disadvantages have out weighed their advantages.

### SUMMARY OF THE INVENTION

The present invention provides a method and system for managing and administering a supplement unemployment benefit plan. The system comprises a secure automated response system, a personal profile database, a benefit profile database, a benefit calculator and means for transferring money to plan members.

Administering a SUB-plan involves many contingent factors which the present invention takes into account in an automated fashion. Several examples of the system and how it may be used follows.

A preferred method for administering a SUB-plan comprises initiating a secure automated response system by entering a character string associated with an individual qualified to receive SUB-plan benefits. In the preferred system the automated response system is accessed and utilized through a telephone. The method automatically verifies that the individual has an active record in a personal profile database. The individual then identifies a specific benefit plan by entering a character string. It is predetermined that the individual is associated with a benefit plan, the profile of the benefit plan being stored on a benefit profile database.

The individuals are automatically verified as members of the benefit plans they identify. After this step an individual identifies whether he has received State unemployment payment for the particular week he is claiming by entering payment identifiers. The payment identifiers comprise check numbers, amount and date. Next, the individual identifies whether he is currently employed or not by entering the character string associated with the affirmation or disaffirmation on the secure automated response system. At many instances an individual may contact a live operator or customer service coordinator.

Once these steps are completed, the calculator automatically calculates the supplemental unemployment benefit for the particular individual by taking the individual's pre-displaced wages and subtracting the appropriate taxes and State unemployment benefit amounts. These amounts are encoded into the benefit profile database utilized by the calculator.

Certain States require different taxing for these benefits. The present invention has these encoded so that the SUB amount may be automatically calculated. Once this is calculated, the system automatically provides for the individual to receive the amount determined by the benefit calculator.

### BRIEF DESCRIPTION OF THE DRAWINGS

FIGS. 1-7 are logic flow diagrams of one embodiment of the invention.

### DETAILED DESCRIPTION

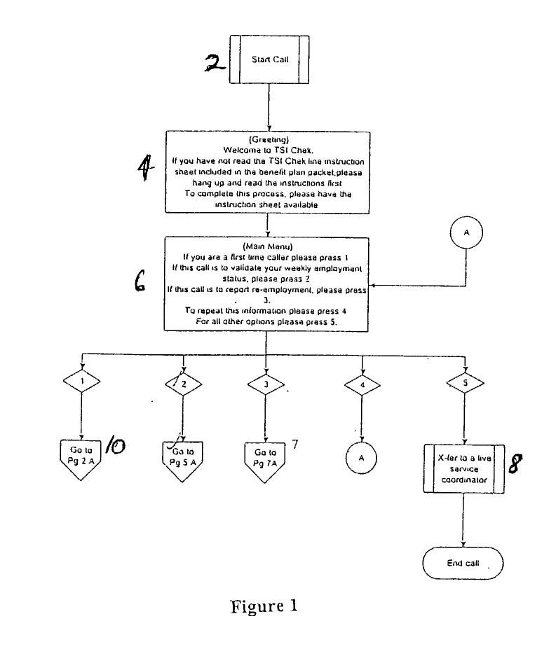

FIG. 1 is a flow diagram depicting an individual's initial contact with the system of the invention. In this embodiment, an individual's call by telephone to the secure automated response system 2 initiates an interactive dialogue with the individual. This dialog begins with the welcome 4 which verifies that the individual has read an instruction sheet included in a benefit plan starter kit that has been put in the individual's possession. Presumably, the individual has been separated from employment and the last employer or client has an administered SUB plan.

The automated response system next verifies, at the main menu 6, if the individual is a first time caller, if the individual is calling to validate his weekly employment status or if the individual is calling to report re-employment. At step 6, the individual also has an opportunity to repeat the information offered by the secured automated response system or to access a live operator for assistance, depicted at step 8.

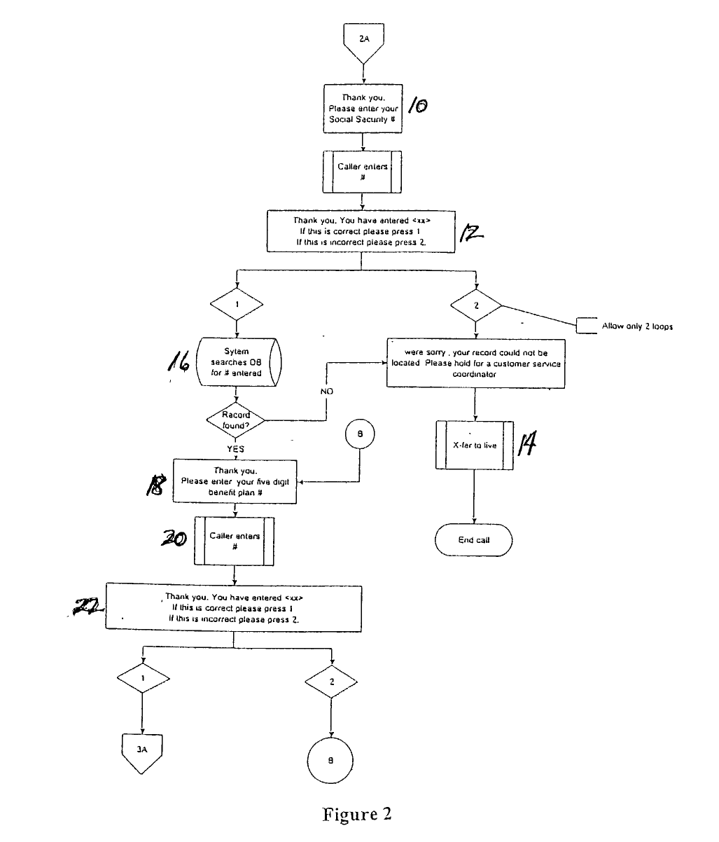

If the individual is a first time caller, the system proceeds to FIG. 2, where, as an initial step, the individual is asked to enter or provide on a telephone touch keypad his social security number 10. The individual next has an opportunity to correct his social security number if a mistake is made 12. If the number does not correspond to the data, the individual may be referred to a live operator 14.

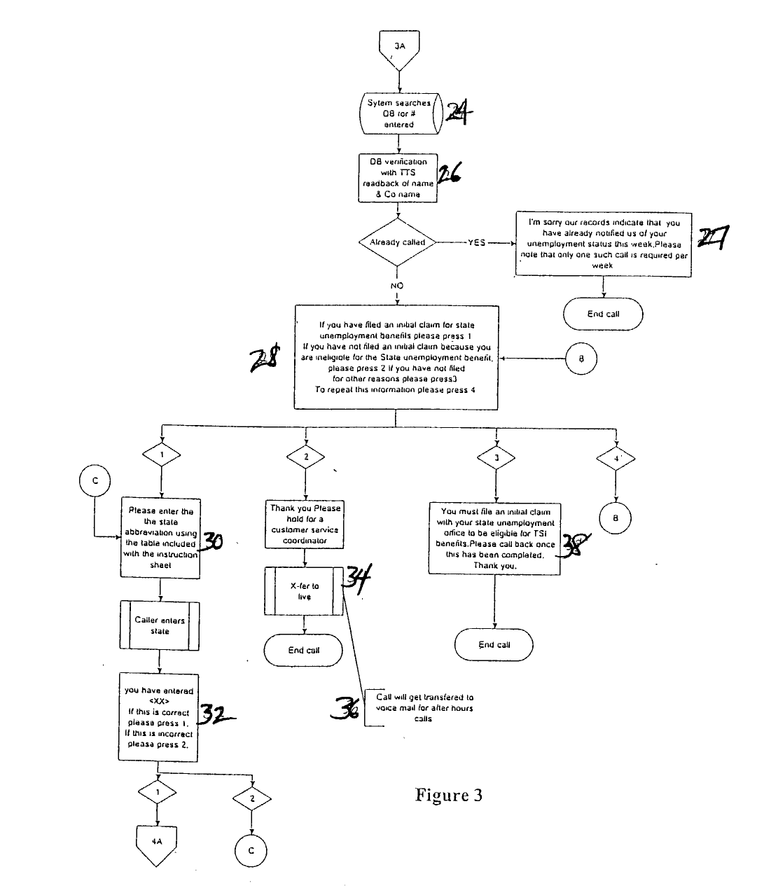

Once the social security number is correct, the automated response system searches the personal profile database using the individual's social security number to access the individual's personal profile 16. After step 16, the individual is requested to enter, via the automated response system, a benefit plan identifier that in the preferred embodiment, is a character string associated with a particular benefit plan 18. The caller enters, in this embodiment, a five digit character string 20, and again has an opportunity to insure that the character string entered is correct 22. If it was not correct, the individual is referred back to 18 where he may re-enter the benefit plan identifier. Once the benefit plan identifier is correctly entered, the automated response system moves logically to FIG. 3.

At step 24 of FIG. 3, the invention searches and identifies the benefit plan entered by the individual. This is verified by reading back the name and other identifiers to the individual 26 by the automated response system. If the individual has already called for the week, he is notified at 27. Otherwise, the system moves logically to block 28 which requests whether the individual has filed an initial claim for State unemployment benefits and if not, is it because the individual is ineligible for the State benefits.

If the individual has filed an initial claim for State unemployment benefits, the invention requests that the individual enter a pre-encoded State abbreviation to identify the State 30 that is paying the unemployment benefits. This is then verified at 32.

If the individual is ineligible for State unemployment benefits, a live operator is provided to proceed further 34. If this call is made after hours, voice mail may be provided 36.

If the individual has not filed an initial claim for State unemployment benefits for some other reason, the individual is requested to file an initial claim and to check back with the system once this is done 38.

Proceeding after logical step 32, once the State is correctly entered, the individual is requested to enter the date the initial claim for State unemployment benefits was filed 40. Caller enters the date by touch pad 42 and the date entered is verified 44.

The individual is requested and enters his predetermined employment benefit registration number 46. The individual then confirms that he is currently employed at 48. If the individual is unemployed, he is told an approximate date of receipt of the SUB benefits and a confirmation number 50. If the individual has answered that he is currently employed, he is referred to a live operator 52 by the system.

After step 50, the invention automatically calculates the supplemental unemployment amount by subtracting from the base amount of the individual's pre-displaced wages, pre-encoded appropriate taxes and State unemployment benefit amounts. The invention then automatically provides for payment to the individual for the amount determined by its calculation.

In one embodiment of the invention, an administrator of the method and system of the invention charges a fee based on the cost savings provided. The cost savings can be calculated as equal to the basic wages and payroll taxes that a company utilizing the invention would have paid to an individual without the benefit of a supplemental unemployment benefit plan minus the amount of benefits actually paid by the company.

The amount actually paid by a company is the supplemental unemployment amount calculated by the invention. Savings are realized through reducing payroll taxes and offsetting benefit payments by amounts received as State unemployment compensation. These are advantages provided by SUB plans which the invention administors and automates.

The administration fee may be a percentage of the realized cost savings. This fee may be automatically charged by the system of the invention.

Another embodiment of the present invention occurs when at logical step 6, a caller signifies that she is calling to validate her weekly employment status. The invention next requests, via the automated response system, that the individual enter her social security number 54. This is verified 56 and the invention proceeds to search a personal profile database to identify the individual 58. If the individual is not found in the database, she is referred to a live operator 60.

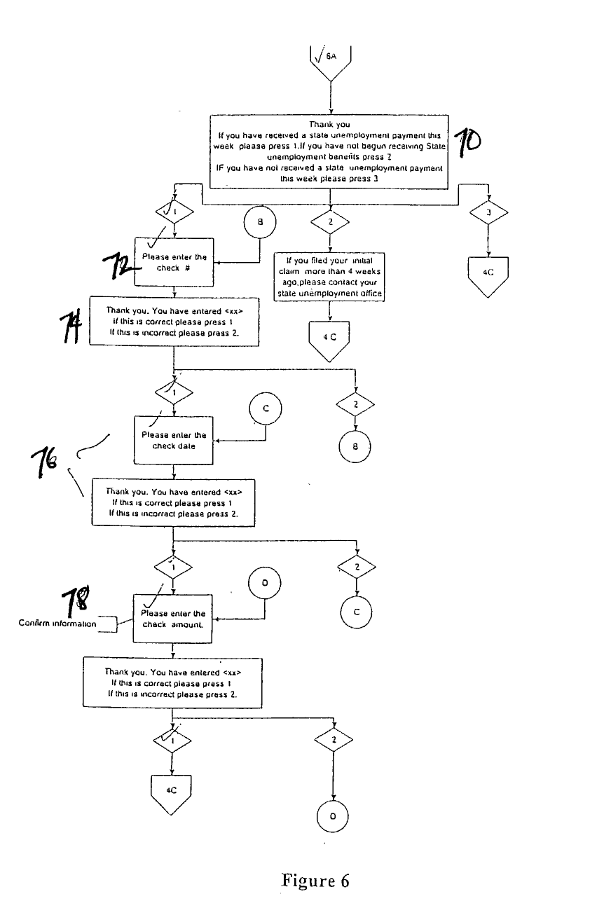

Once the individual is found on the personal profile database, the system requests and the caller enters her benefit plan number 62 which is verified at 64. The benefit profile database is searched for the individual's social security number to verify the individual's membership in the particular benefit plan 66. If the individual has not registered she is referred to FIG. 3, logic box 28 or to a live operator 68. Once the benefit profile is confirmed the logic flow is to FIG. 6.

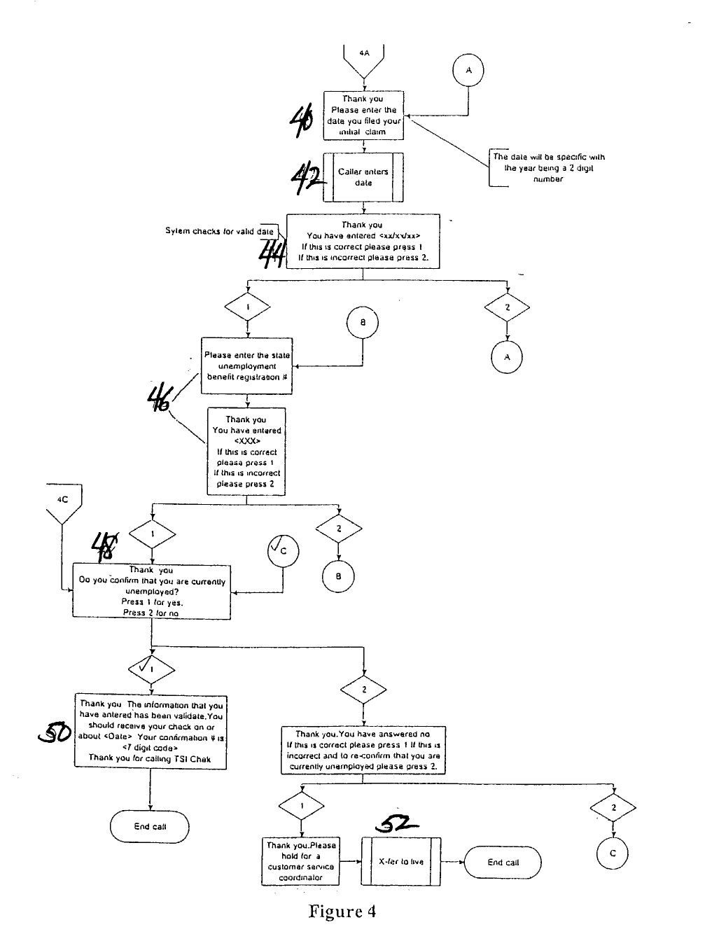

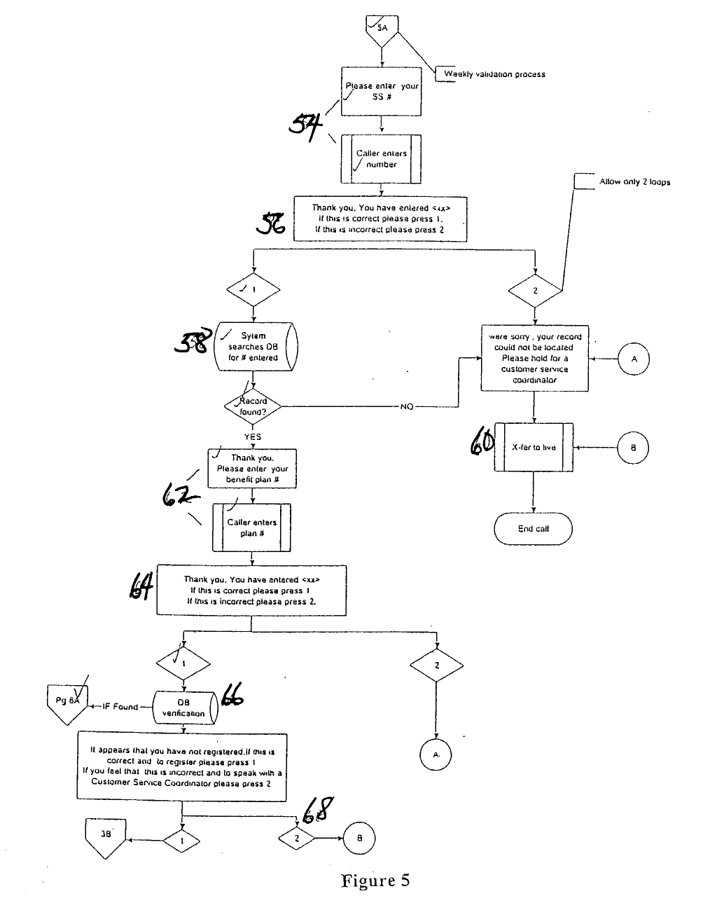

FIG. 6 begins at box 70 which has the automatic response system of the invention requesting whether the individual has received State unemployment payment for the week she is calling. If she has not received such benefits she is automatically referred back to logic box 48. If she has received her state unemployment payment she is requested to enter a check number 72 which is verified 74 via the automated response system. The check date is then entered and its correctness verified 76 and the check amount is entered and also confirmed 78. Once this process is complete, the individual is referred back to box 48 of FIG. 4 and proceeds from there.

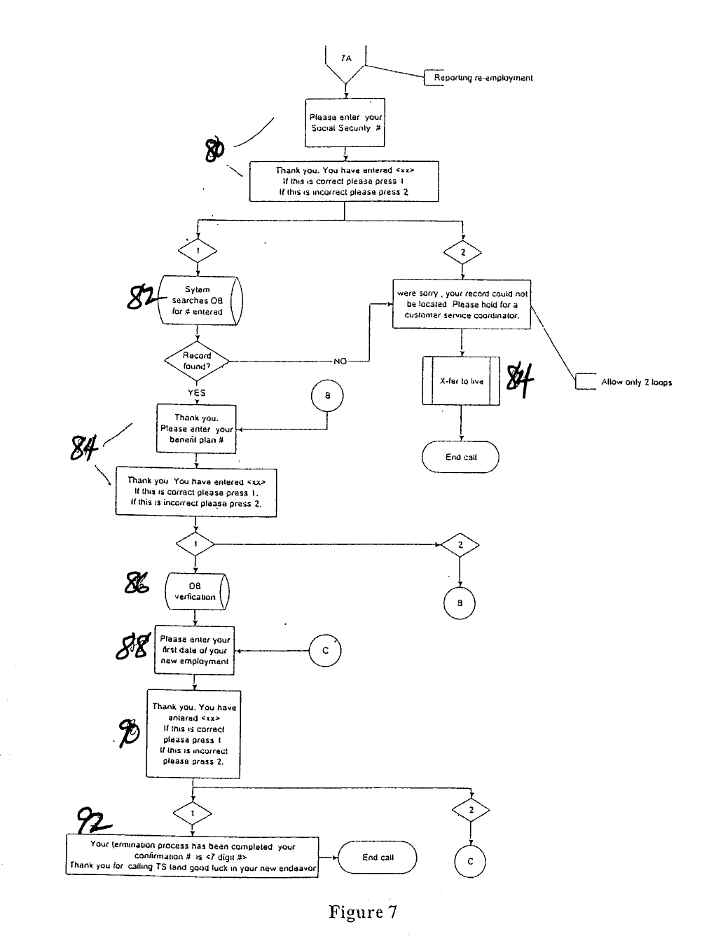

If at box 6 the individual is calling to report reemployment, she is referred to FIG. 7 which initially requests the individual's social security number and confirmation of such 80. The system searches the personal profile database 82 for the individual's record, if the record is not located the individual may be referred to a live operator 84. Once the record is identified the system requests and confirms the entrance of a benefit plan number 84. The benefit profile database is automatically verified 86, by corresponding the individual with the benefit plan.

After this is completed, the caller is requested to enter her first date of new employment 88, which is verified 90. The system then proceeds to automatically terminate this individual from the SUB plan and the individual is given a confirmation number 92.

One method for providing and establishing personal profiles, benefit plans, benefit profiles, employment status and other required information to populate the system is for an administrator to collect this data from a client and individual. This can be done in written form or electronically by the administrator providing forms to be completed by the client and/or administrator.

The administrator can also provide reports to clients detailing the systems use of the data provided. Each client's data may reside in a particular sector of a database. The database information may be further broken down to types of data for each client.

One embodiment for populating the profile databases begins by the administrator sending forms to a client with fields comprising company name, website, addresses, employee identification numbers, States unemployment IDS, State unemployment insurance percent rates, contact information and SIC code.

To populate a database for an individual participant the administrator collects information that identifies the participant. The administrator also collects information that identifies the participant with a plan that has been described on the database.

A personal profile database is constructed by such data as an unemployed individual's name, address, telephone number, social security number, tax withholding status and tax filing status.

A benefit plan is defined on a database by data comprising eligible individuals, a client name, a client address, a client's employer identification number, States unemployment identification numbers, appropriate tax rates and contact information. The client is typically a company using an administrator to manage and operate a SUB plan via the invention for them.

The benefit profile defines the particular benefits for a particular individual on a benefit plan. The data in a benefit profile may include the individual's per pay rate, primary taxing State, benefit duration period, and year to date wages at the time of the individual's date of separation from employment.

The client will generally communicate with the administrator to keep individual participant and client data updated. This may be accomplished electronically with the data being imported directly to the database.

Accordingly, it should be readily appreciated that the system and method of the present invention has many practical applications. Additionally, although the preferred embodiments have been illustrated and described, it will be obvious to those skilled in the art, that various modifications can be made without departing from the spirit and scope of this invention. Such modifications ought to be considered as included in the following claims.

What is claimed:

1. A method for administering supplemental unemployment benefits to individuals comprising:
initiating a secure automated response transaction by entering via means of an automated response system a character string associated with an individual;
automatically corresponding the individual with a predetermined personal profile as part of the benefit plan;
identifying a predetermined benefit plan by entering via the automated response system a character string associated with the benefit plan;
automatically corresponding the individual with a predetermined benefit profile;
identifying that the individual has received State unemployment payment for a particular week by entering by means of the automated response a character string associated with affirming receipt;
identifying that the individual is currently unemployed by entering via the automated response system a character string associated with affirming that the individual is unemployed;
automatically calculating the supplemental unemployment benefit amount by using as a minuend the base amount of the individual's pre-displaced wages and subtracting the pre-encoded appropriate taxes and state unemployment benefit amount;
automatically providing for payments to the individual for the amount determined by the benefit calculation.

2. A method for administering supplemental unemployment benefits as in claim 1 wherein:
the predetermined personal profile comprises the individual's name, address, telephone number, social security number, tax withholding status, and tax filing status.

3. A method for administering supplemental unemployment benefits as in claim 1 wherein:
the predetermined benefit plan comprises eligible individuals, a client name, a client address, a client employee identification number, a State unemployment identification number, tax rates and contact information.

4. A method for administering supplemental unemployment benefits as in claim 1 wherein:
the benefit profile comprises the individual's per pay rate, primary tax State, benefit duration, and year to date wages at time of individual's date of separation from employment.

5. A method for administrating supplemental unemployment benefits as in claim 1 wherein:
the individual may identify that State unemployment benefits have not been received.

6. A method for administrating supplemental unemployment benefits as in claim 1 wherein:
the individual may identify a status of current employment.

7. A method for administering supplemental unemployment benefits as in claim 1 further comprising:
providing for the individual to interact with a customer service coordinator.

8. A method for administering supplemental unemployment benefits as in claim 1 further comprising:
providing for the individual to have information repeated by the automated response system.

9. A method for administering supplemental unemployment benefits as in claim 1 further comprising:
providing for the individual to correct incorrectly entered information through the automated response system.

10. A method for administering supplemental unemployment benefits as in claim 1 further comprising:
providing for the individual to have an inactive personal profile and not receive benefits.

11. A method for administering supplemental unemployment benefits as in claim 1 further comprising:
charging a fee from a last employer of the individual equal to a percent of a basic wage and payroll taxes amount as a minuend and subtracting the payment to the individual.

12. A method for administering supplemental unemployment benefits as in claim 1 wherein:
benefit plan data found in a benefit profile comprises the individual's pre-displaced wages, taxes the individual is liable for and State unemployment benefit amounts.

13. A method for administering supplemental unemployment benefits as in claim 1 wherein:
the automated response system is a telephonic system.

14. A method for administering supplemental unemployment benefits as in claim 1 wherein:
the automated response system is an interactive computer based network.

15. A method for administering supplemental unemployment benefits comprising:
initiating interactive communication between a user and an automated response system;
querying via the automated response system the user to identify a predetermined personal profile and benefits profile;
confirming via the automated response system the user has identified the correct personal profile and benefits profile;
providing via the automated response system for the user to correct incorrectly answered queries;
automatically calculating the user's supplemental unemployment benefit amount by using as a minuend the base amount of the individual's pre-displaced wages and subtracting the appropriate taxes and state unemployment benefit amount, and;
providing the benefit determined by the calculator to the individual.

16. A method for administering supplemental unemployment benefits as in claim 15 wherein:
the profiles are stored on a database system that is queried through the automated response system.

17. A method for administering supplemental unemployment benefits as in claim 15 further comprising:
confirming via the automated response system a status of the users State unemployment benefits.

18. A method for administering supplemental unemployment benefits as in claim 15 further comprising:
providing for the user to interact with a customer service coordinator.

19. A method for administering supplemental unemployment benefits as in claim 15 further comprising:
providing for the automatic termination of a personal profile.

20. A method for administering supplemental unemployment benefits as in claim 15 further comprising:
charging a negotiated fee from a last employer of the individual equal to a percent of a basic wage and payroll taxes amount as a minimal and subtracting the payment to the individual.

21. A system for automating the administration of a supplemental unemployment benefit plan comprising:
an interactive automated response system that is initiated by a user;
a personal profile database in electronic communication with the automated response system;
a benefit plan database in electronic communication with the automated response system; and
a calculator in electronic communication with the benefit profile database wherein a user identifies a personal profile and a benefit plan via the automated response system and the calculator calculates a benefit amount for the user based on a determined benefit profile.

22. A system for administering supplemental unemployment benefits as in claim 21 wherein:
the automated response system is a telephonic system.

23. A system for administering supplemental unemployment benefits as in claim 21 wherein:
the automated response system is an interactive computer based network.
